(19) United States
(12) Patent Application Publication
(10) Pub. No.: US 2003/0189376 A1
(43) Pub. Date: Oct. 9, 2003

(54) Electric retarder/generator for additional braking energy

(76) Inventors: Mark Schneider, Royal Oak, MI (US); Larry W. Bowman, Troy, MI (US); Paul Raymond Sieber, Rochester Hills, MI (US); Robert W. Hildebrand, Rochester Hills, MI (US); Michael Everett Johnson, Rochester, MI (US); James R. Brichta, Highland, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/116,551

(22) Filed: Apr. 4, 2002

(51) Int. Cl. B60T 8/52

(52) U.S. Cl. 303/112

(57) ABSTRACT

A driveline assembly for a motor vehicle includes a housing containing at least a portion of a driveline component and a wet disk brake assembly. The wet disk brake assembly includes a plurality of friction disks immersed within lubricating/cooling oil contained within the housing. Actuation of the friction disks creates a braking force to slow and stop rotation of an axle and creates heat that can cause premature deterioration of the lubricating/cooling oil that in turn can cause premature failure of driveline components and brake assembly components. An electric generator driven by a driveline component is included within the housing to provide additional braking energy to reduce the braking load on the wet disk brake assembly such that the lubricating/cooling oil maintains temperatures within acceptable predetermined operational limits without a separate oil cooling system.

### BACKGROUND OF THE INVENTION

This invention relates to a vehicle braking system including a regenerative braking system and a wet brake system, and specifically a regenerative braking system to provide a portion of the required braking energy to reduce heat build up in the wet brake system.

In off-highway type vehicles, oil in the brake and axle assemblies tends to heat up during braking applications. In many cases, especially in the case of liquid cooled wet disc brakes, the generated heat exceeds that which can be dissipated by the axle assembly or brake assembly using normal passive methods.

The excess heat should be dissipated to maximize axle and brake component life and performance. The fatigue performance of components such as gears, for example, decreases with incremental rises in temperature. By maintaining an optimal temperature for such components, the fatigue performance is enhanced.

Vehicle manufacturers and suppliers have designed complex and often costly cooling systems in an attempt to regulate component temperature during braking applications. Alternative heat dissipation techniques are needed.

Regenerative braking is known in the art and is typically implemented in electric powered vehicles as a means of recapturing energy that would otherwise be lost to frictional heat generation. Typically, a torque load is created by an electric motor generating electric power to charge a battery and provide a braking force that aids in slowing and stopping the vehicle. The electric motor is configured as a generator that generates a braking torque transmitted to the wheels. However, the regenerative braking power is typically insufficient to provide all of the necessary braking force to stop a vehicle.

It is desirable to develop a braking system that provides the necessary braking force to completely stop a vehicle, specifically large off road vehicles, while eliminating the need for independent liquid cooling systems.

### SUMMARY OF THE INVENTION

An embodiment disclosed in this application is a driveline assembly for a motor vehicle including a electric generator driven by a driveline component to impart braking torque to aid friction brakes and reduce heat build up to eliminate the need for a separate cooling system.

The driveline assembly includes a housing supporting a rotating driveline component. The housing contains a friction brake assembly. In an embodiment of this invention the friction brake assembly is a wet disk brake comprising a plurality of friction disks immersed within lubricating/cooling oil contained within the housing. Actuation of the friction disks creates a braking force to slow and stop rotation of an axle. Engagement of the friction disks also generates a great deal of heat during certain braking conditions. The heat generated from the friction disks during braking can cause premature deterioration of the lubricating/cooling oil that in turn can cause premature failure of driveline components and brake assembly components.

Prior art systems include an oil cooling system to dissipate heat generated during braking. Such systems add to the cost and complexity of the driveline assembly. This invention includes a electric generator driven by a driveline component within the housing to provide additional braking energy such that the lubricating/cooling oil maintains temperatures within acceptable predetermined operational limits.

The electrical generator includes a driven gear engaged to a drive gear disposed on an axle of the driveline assembly. The electric generator converts the mechanical rotational energy from the axle to electric energy. Generation of electrical energy by the electrical generator imparts a braking torque on the driveline component to reduce the amount of braking force required from the frictional brake assembly. In other words, the total braking force required for the slowing or stopping the motor vehicle is divided between the electric generator and the friction braking assembly. Addition of the braking torque imparted by the electrical generator reduces the braking force required from the friction braking assembly to such a magnitude that the lubricating/cooling oil never reaches temperatures that cause deterioration. This eliminates the need to include a cooling system for the lubricating/cooling oil.

A controller is in communication with the electric generator and a resistive load to govern the generation of electrical power. The resistive load placed on the electric generator and thereby the braking torque exerted on the driveline component is controlled by the controller and varied depending on specific predetermined conditions. The conditions include a position of a brake actuation pedal. The resistive load on the electric generator is varied in response to a position of the brake pedal such that the amount of braking torque from the electrical generator varies relative to the braking force exerted by the friction braking assembly. Varying the load on the electric generator varies the amount of braking torque applied to the driveline component according to conditions of the vehicle.

A temperature sensor is disposed within the housing to sense the temperature within the housing. The temperature sensor detects the temperature of the lubricating/cooling fluid and the controller adjusts the electrical load in proportion to the temperature.

The electric generator of this invention imparts a braking torque to aid the friction brakes and reduce heat build up to provide the necessary braking force to completely stop a vehicle, specifically large off road vehicles and eliminate the need for an independent liquid cooling systems.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a partial schematic illustration of the subject braking system.

FIG. 2 is a partial schematic illustration of another embodiment of the subject braking system; and

FIG. 3 is a partial schematic illustration of another embodiment of the subject invention.

### DETAILED DESCRIPTION OF THE PREFERRED EMBODIMENT

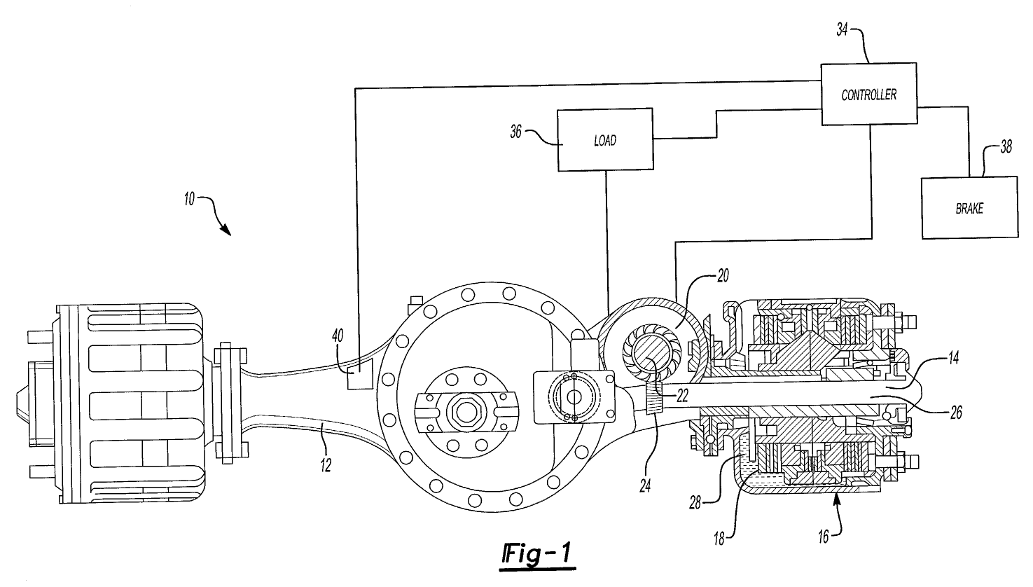

Referring to the Figures, wherein like numerals indicate like or corresponding parts throughout the several views, a driveline assembly for a motor vehicle is generally indicated at 10 in FIG. 1 and includes a housing 12 containing at least a portion of a driveline component. A driveline component refers to any rotating driveline component as is known by one skilled in the art, including specific examples discussed in detail for each of disclosed embodiment illustrated in the figures. In FIG. 1, the driveline component is a drive axle 26.

Preferably, the driveline assembly 10 is configured for use in a large off-road vehicles. The housing 12 contains a friction brake assembly 16. Preferably, the friction brake assembly 16 is a direct axle type brake commonly known as a wet disk brake. The wet disk brake includes a plurality of friction disks 18 immersed within lubricating/cooling oil 28 contained within the housing 12. Actuating the friction disks 18 creates a braking force to slow and stop rotation of the axle shaft 26. Engagement of the friction disks 18 generates a great deal of heat during certain braking conditions. The heat generated from the friction disks 18 during braking can cause premature deterioration of the lubricating/cooling oil 28 that in turn can cause premature failure of the brake assembly components 16.

This invention includes an electric generator 20 driven by a driveline component 14 and disposed within the housing 12 to provide additional braking energy such that the lubricating/cooling oil 28 maintains temperatures within acceptable predetermined operational limits.

The electrical generator 20 includes a driven gear 22 engaged to a drive gear 24 disposed on the axle shaft 26 of the driveline assembly 10. The electric generator 20 converts the mechanical rotational energy from the axle shaft 26 to electric energy. Generation of electrical energy by the electrical generator 20 imparts a braking torque on the axle shaft 26 to reduce the amount of braking force required from the frictional brake assembly 16. In other words, the total braking force required for the slowing or stopping the motor vehicle is divided between the electric generator 20 and the friction braking assembly 16. Addition of the braking torque imparted by the electrical generator 20 reduces the braking force required from the friction braking assembly 16 to such a magnitude that the lubricating/cooling oil 28 never reaches temperatures that cause deterioration. This eliminates the need for a cooling system. Note that it is within the contemplation of this invention to use any type of electric generator as known to one skilled in the art.

The electric generator 20 can be mounted at various locations with respect to the housing 12. Preferably, the electrical generator 20 is mounted within the housing 12 and driven by the axle shaft 26. The axle shaft 26 includes drive gear 24 to drive a driven gear 22 of the electric motor 20.

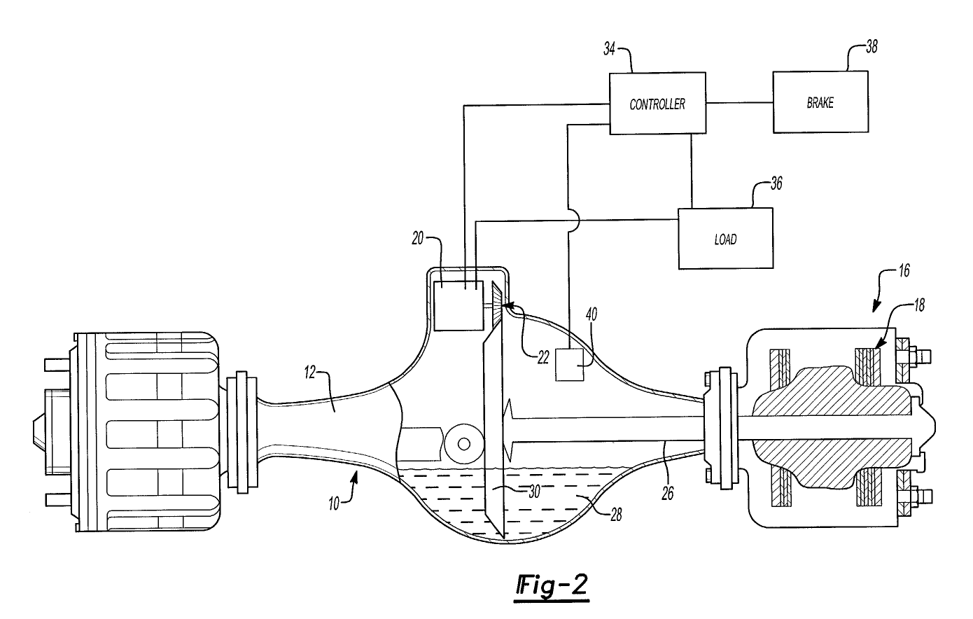

Referring to FIG. 2, the electrical generator 20 is positioned within the housing 12 and driven by a differential gear 30. In this embodiment the electric motor 20 and driven gear 22 are engaged to the differential gear 30 so that application of a resistive load 36 applies a braking torque to the entire driveline to slow the motor vehicle. The electric motor 20 is preferably mounted within the housing 12 and is in electric communication with a controller 34 and the resistive load 36. The friction brake assembly 16 applies some portion of the braking torque required to slow the vehicle. The electric motor 20 applies a braking torque to the differential gear 30 that is transmitted through to the axle shaft 26.

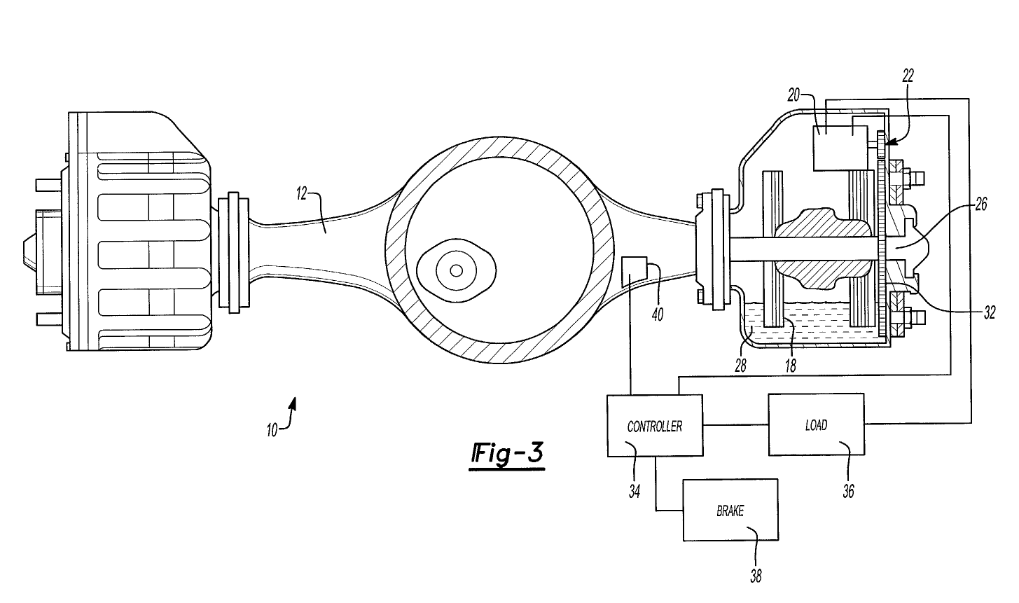

Referring to FIG. 3, the electrical generator 20 is positioned within the housing 14 to be driven by a wheel end gear 32. It is within the contemplation of this invention to install the electric generator 20 in any location within the driveline assembly 10 to exert braking torque from the electrical generator 20 to slow and stop the vehicle. Application of braking force by the electric generator 20 at the wheel end gear 32 slows the axle shaft 26 by a proportional application of the resistive load 36. One electric generator 20 disposed at one of the ends of the driveline assembly 10. Preferably, in this embodiment, an electric generator 20 is disposed at each end of the driveline assembly, such that each friction braking assembly 16 includes an electric generator 20 to produce an additional braking torque to slow and stop the motor vehicle.

Referring to FIG. 1, a controller 34 is in communication with the electric generator 20 and a resistive load 36 to govern the generation of electrical power. The resistive load is preferably a battery that is charged with electric power generated by the electrical generator 20. Energy from the battery is used in various operating systems on board the motor vehicle. The resistive load 36 placed on the electric generator 20 is controlled to vary the magnitude of braking torque exerted on the driveline component 14, which in FIG. 1 is the axle shaft 26. The magnitude of braking torque varies in response to predetermined vehicle operating condition such as measured temperature and brake pedal 38 actuation. Braking torque generated by the electric generator 20 may be varied in response to other operating conditions of the motor vehicle as would be understood by one knowledgeable in the art and are within the contemplation of this invention.

The resistive load 36 on the electric generator 20 is varied in response to a position of the brake pedal 38 such that the amount of braking torque exerted by the electrical generator 20 varies relative to the braking force exerted by the friction braking assembly 16. Although a brake pedal 38 is schematically illustrated in the preferred embodiment, it is within the contemplation of this invention to measure the position of any type of brake actuation device as is known by one skilled in the art. The proportion of braking torque from the electric generator 20 varies with the position of the brake pedal 38. Varying the load 36 on the electric generator 20 varies the amount of braking torque applied to the axle shaft 26 according to current operating conditions of the motor vehicle. Such conditions include light braking, where braking torque from the electrical generator 20 composes the greatest proportion of the total braking force, to panic stop braking where both the electric generator 20 and the friction braking assembly 16 contribute to a maximum braking force.

A temperature sensor 40 disposed within the housing 14 senses the temperature within the housing 14. Preferably, the temperature sensor 40 detects the temperature of the lubricating/cooling fluid 28 and the controller 34 adjusts the electrical load 36 in proportion to the temperature. The lubricating/cooling oil 28 is most beneficial within a predetermined temperature range as determined by the type of oil and vehicle application. Actuation of the electric generator 20 occurs once the optimal temperature range of the lubricating/cooling oil 28 is attained. This accommodates operation of the motor vehicle in various extreme temperature conditions. In extreme cold climates, the lubricant/cooling oil 28 may never reach a temperature where excessive heat is a problem and therefore the electric generator is not actuated to provide braking torque. However, in extreme hot climates the electric generator 20 will operating at maximum loads to provide as great an additional braking torque as possible with the specific configuration to maintain temperatures within optimal limits.

During normal operation, the friction braking assembly 16 and the electric generator 20 operate in concert to provide the total braking force required. An operator depressing the brake pedal 38 actuates the friction braking system 16. The controller 34 activates the electric generator 20 by increasing the load 36 when conditions require additional braking force to maintain optimal temperatures. The determination of the need for additional braking force is dependent on the temperature of the lubricating/cooling fluid 28. In other words, during initial start up and during the first braking action of the motor vehicle, very little of the total braking force will come from the braking torque exerted by the electrical generator 20. However, as the duration of use increases causing the lubricant/cooling oil 28 to heat up, braking torque from the electrical generator 20 will compose a greater percentage of the total braking force to maintain optimal temperature within the housing 14 and prevent premature damage to driveline and friction brake assembly components.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. A braking system for a motor vehicle comprising
an axle housing including a support for a rotating a driveline component,
a friction braking assembly supported relative to said axle housing for generating a frictional braking force;
an electric generator driven by said rotating driveline component for varying a resistive load to provide a retarding brake force that supplements said frictional braking force to reduce the braking load on said friction braking assembly and to reduce heat generated from said friction braking system.

2. The system of claim 1, wherein said friction braking system is composed of a plurality of friction disks disposed within said housing.

3. The system of claim 2, wherein said housing includes a quantity of oil for lubricating said rotating driveline component and wherein heat generated from said friction disks is transmitted to said oil.

4. The system of claim 1, wherein said electric generator is coupled to said rotating driveline component to generate electric power to achieve a desired braking torque on said rotating driveline component.

5. The system of claim 1, further including a controller for controlling power generation of said electric generator, and thereby the amount of braking torque exerted on said driveline component.

6. The system of claim 5, wherein said controller controls said load placed on said electric generator to govern the proportion of braking force exerted on said driveline component relative to braking force applied by said friction braking assembly.

7. The system of claim 5, further including a temperature sensor to sense the temperature within said housing.

8. The system of claim 7, wherein said temperature sensor detects a temperature of said cooling oil within said housing.

9. The system of claim 7, wherein said controller controls a load placed on said electric generator to govern the amount of braking force exerted on said driveline component in response to a temperature sensed by said temperature sensor.

10. The system of claim 6, wherein said controller controls a load placed on said electric generator to govern the amount of braking force exerted on said driveline component in response to actuation of a brake pedal.

11. The system of claim 10, wherein said controller increases said load on said electric generator in proportion to actuation of said brake actuator.

12. The system of claim 1, wherein said driveline component is further defined as an axle including a drive gear and said electric generator includes a driven gear engaged with said drive gear.

13. The assembly of claim 1, wherein said driveline component is a differential gear.

14. The assembly of claim 1, wherein said driveline component is a wheel end gear.

15. The system of claim 1, wherein electric power generated by said electric generator charges a battery.

16. The system of claim 1, wherein a variable resistor creates an electric load on said electric generator in response to actuation of a brake pedal.

17. The assembly of claim 1, wherein said friction brake assembly includes a plurality of friction disks are operably attached to said rotating driveline component and enclosed within said housing such that oil contained within said housing is in communication with said plurality of friction disks.

18. A driveline assembly for a motor vehicle comprising;
an axle housing including a support for a rotating driveline component;
a friction braking assembly supported relative to said axle housing for generating a frictional braking force;
an electric generator engaged to said rotating driveline component; and
an resistive load placed on said electric generator to create a braking torque transmitted to said rotating driveline component to supplement the braking load from said friction braking assembly and reduce heat generated from said friction braking assembly.

19. The assembly of claim 18, further including a controller in communication with said electric generator and said electric load to control said electric load in proportion to said braking load required from said friction braking assembly.

20. The assembly of claim 19, wherein said axle housing contains a temperature sensor for sensing a temperature within said axle housing, and said controller is in communication with said temperature sensor such that said resistive load on said electric generator is varied in proportion to said temperature.

21. The assembly of claim 18, wherein said driveline component is an axle including a drive gear, and said electric generator includes a driven gear engaged to said drive gear.

22. The assembly of claim 18, wherein said driveline component is a differential gear.

23. The assembly of claim 18, wherein said driveline component is a wheel end gear.

24. The assembly of claim 18, wherein said friction brake assembly includes a plurality of friction disks operably attached to said rotating driveline component and enclosed within said housing such that oil contained within said housing is in communication with said plurality of friction disks.

25. A method of braking a motor vehicle comprising the steps of;
a. providing a friction brake assembly enclosed within an axle housing to retard rotation of a rotating driveline component;
b. driving an electric generator with the rotating driveline component;
c. applying a resistive load to said electric generator such that the electric generator exerts a braking torque to said rotating driveline;
d. varying the applied resistive load in proportion to a predetermined set of conditions.

26. The method of claim 25, further including a controller in communication with the electric generator and the resistive load, said step (d.) is further defined by varying the resistive load with the controller in proportion with braking torque applied by the friction brake assembly.

27. The method of claim 26, further including a brake actuating lever movable between an engaged position and a disengaged position, said step(d) further defined by varying the resistive load proportional to a position of the brake actuating lever.

28. The method of claim 25, further including a temperature sensor for measuring a temperature within the axle housing, said step (d) is further defined by varying the resistive load in response to changes in temperature measured within the axle housing.
